(19) United States
(12) Patent Application Publication
(10) Pub. No.: US 2026/0179567 A1
(43) Pub. Date: Jun. 25, 2026

(54) DISPLAY DEVICE AND DRIVING METHOD THEREOF

(71) Applicant: InnoLux Corporation, Miao-Li County (TW)

(72) Inventors: Yi-Shiuan CHERNG, Miao-Li County (TW); Chia-Hao TSAI, Miao-Li County (TW); Yung-Hsun WU, Miao-Li County (TW)

(73) Assignee: InnoLux Corporation, Miao-Li County (TW)

(21) Appl. No.: 19/401,334

(22) Filed: Nov. 25, 2025

Related U.S. Application Data
(60) Provisional application No. 63/738,767, filed on Dec. 25, 2024.

(30) Foreign Application Priority Data
Sep. 1, 2025 (CN) 202511236008.2

(51) Int. Cl. G09G 3/3266; G09G 3/00

(52) U.S. Cl. CPC G09G 3/3266; G09G 3/006; G09G 2310/0286; G09G 2320/043; G09G 2320/06

(57) ABSTRACT

The disclosure provides a display device and a driving method thereof. The display device includes a substrate, a plurality of pixels, a first gate driver, a second gate driver, and a control circuit. The plurality of pixels are disposed on the substrate. The first gate driver has a first output terminal coupled to the plurality of pixels. The second gate driver has a second output terminal commonly coupled to the plurality of pixels. The control circuit is electrically coupled to the first gate driver for selectively disabling the first gate driver. When the first gate driver is disabled, the first output terminal is in a floating state.

### BACKGROUND OF THE DISCLOSURE

### 1. FIELD OF THE DISCLOSURE

The present disclosure relates to a driving technology for an electronic device, and more particularly, to a driving circuit for a display device and a driving method thereof.

### 2. DESCRIPTION OF THE PRIOR ART

In the manufacturing process of a display panel, to ensure the normal functionality of internal components such as the pixel array and thin-film transistors (TFTs), a light-up test is typically performed before the panel is bonded with an external gate driver chip. For display panels with large sizes, high resolution, or narrow bezel designs, the resistance-capacitance (RC) load on the gate lines is relatively heavy. During the testing phase, if the gate lines are driven directly by the signals from the test equipment, the driving capability may be insufficient, leading to signal attenuation and inaccurate test results. To address this issue, the present disclosure proposes a design that integrates an additional Gate on Panel (GOP) circuit on the panel, utilizing the superior driving capability of this GOP circuit to complete the light-up test. However, after the test is completed and the external gate driver chip is bonded, this GOP circuit must be disabled to prevent its output signal from conflicting with the signal from the external gate driver chip, which would interfere with the normal display of the display device. However, using traditional processing methods (such as physical methods like laser cutting) to disconnect the GOP circuit from the pixels increases production costs and complexity. The residual metal traces left at the edge of the panel may also pose a risk of electrostatic discharge (ESD) or reduce the long-term reliability of the product.

### SUMMARY OF THE DISCLOSURE

An embodiment of the present disclosure provides a display device, which includes a substrate, a plurality of pixels, a first gate driver, a second gate driver, and a control circuit. The plurality of pixels are disposed on the substrate. The first gate driver has a first output terminal coupled to the plurality of pixels. The second gate driver has a second output terminal commonly coupled to the plurality of pixels. The control circuit is electrically coupled to the first gate driver for selectively disabling the first gate driver. When the first gate driver is disabled, the first output terminal is in a floating state.

Another embodiment of the present disclosure provides a driving method for a display device. The display device includes a substrate, a plurality of pixels disposed on the substrate, a first gate driver, a second gate driver, and a control circuit. The first gate driver and the second gate driver are commonly coupled to the plurality of pixels. The driving method includes: in a first driving mode, enabling the first gate driver to provide a first gate driving signal to the plurality of pixels; and in a second driving mode, disabling the first gate driver, causing the output terminal of the first gate driver to be in a floating state, and enabling the second gate driver to provide a second gate driving signal to the plurality of pixels.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 is a schematic block diagram of a display device according to some embodiments of the present disclosure.

FIG. 2 is a circuit diagram of one implementation of the circuit shown in FIG. 1.

FIG. 3 is a circuit diagram of another implementation of the circuit shown in FIG. 1.

FIG. 4 is a schematic block diagram of a display device according to another embodiment of the present disclosure.

FIG. 5 is a circuit diagram of one implementation of the circuit shown in FIG. 4.

FIG. 6 is a circuit diagram of another implementation of the circuit shown in FIG. 4.

FIG. 7 is a circuit diagram of yet another implementation of the circuit shown in FIG. 4.

FIG. 8 is a circuit diagram of still another implementation of the circuit shown in FIG. 4.

### DETAILED DESCRIPTION

The present disclosure can be understood by referring to the following detailed description in conjunction with the accompanying drawings. It should be noted that, for ease of understanding for the reader and for the simplicity of the drawings, many of the drawings in the present disclosure only depict a portion of an electronic device, and specific components in the drawings are not drawn to actual scale. In addition, the number and size of each component in the figures are for illustrative purposes only and are not intended to limit the scope of the present disclosure.

Certain terms are used throughout the description and the appended claims to refer to specific components. Those skilled in the art should understand that manufacturers of electronic devices may refer to the same component by different names. This document does not intend to distinguish between components that have the same function but different names.

In the following description and claims, the terms "comprising," "including," and "having" are open-ended terms and should therefore be interpreted as "including, but not limited to...". Therefore, when the terms "comprising," "including," and/or "having" are used in the description of the present disclosure, they specify the presence of the corresponding features, regions, steps, operations, and/or components, but do not preclude the presence of one or more other corresponding features, regions, steps, operations, and/or components.

Directional terms mentioned herein, such as "up," "down," "front," "back," "left," "right," etc., are only with reference to the orientation of the accompanying drawings. Therefore, the directional terms used are for illustrative purposes and not for limiting the present disclosure. In the drawings, each figure illustrates the general features of the methods, structures, and/or materials used in a specific embodiment. However, these drawings should not be construed as defining or limiting the scope or nature covered by these embodiments. For example, for the sake of clarity, the relative size, thickness, and position of each layer, region, and/or structure may be reduced or enlarged.

When a corresponding component (such as a layer or region) is referred to as being "on" another component, it can be directly on the other component (i.e., no component exists between them), or there may be other components between them. In addition, when a component is referred to as being "on" another component, the two have a vertical up-down relationship, and this component can be above or below the other component, and this up-down relationship depends on the orientation of the device.

It should be understood that when a component or layer is referred to as being "connected to" another component or layer, it can be directly connected to the other component or layer (i.e., no component or layer exists between them), or there may be an intervening component or layer. In addition, when a component is referred to as being "coupled to another component (or its variants)," it can be directly electrically connected to the other component, or indirectly connected (e.g., indirectly electrically connected) to the other component through one or more components.

In the present disclosure, when a component is "disconnected" from another component, an electrical signal cannot flow between the two components during a specified time interval.

Ordinal numbers such as "first," "second," etc., used in the description and claims are used to modify elements, and they do not in themselves imply or represent that the element(s) have any preceding ordinal number, nor do they represent the order of one element with respect to another, or the order in a manufacturing method. The use of these ordinal numbers is only to clearly distinguish an element with a certain name from another element with the same name. The claims and the description may not use the same terms; accordingly, a first component in the description may be a second component in the claims.

It should be noted that the features in several different embodiments described below can be replaced, reorganized, and mixed to complete other embodiments without departing from the spirit of the present disclosure. As long as the features between the various embodiments do not violate the spirit of the present disclosure or conflict with each other, they can be arbitrarily mixed and matched.

The display device of the present disclosure can also be applied in various electronic devices. The electronic device can be a planar, curved, bendable, stretchable, flexible, or rollable electronic device, but is not limited thereto. The electronic device can include a display device, a light-emitting device, an antenna device, a sensing device, a medical device, a tiling device, or any combination thereof, but is not limited thereto. The display device can be a non-self-emissive display device (e.g., a liquid crystal display, a reflective display, etc.) or a self-emissive display (e.g., an organic light-emitting diode display, a quantum dot light-emitting diode display, a micro light-emitting diode display, etc.). The display device can be a television, a computer monitor, a laptop, a tablet computer, a smartphone, a digital signage, a wearable device, a vehicle display device, a transparent display device, a virtual reality device, or an augmented reality device, but is not limited thereto. The light-emitting device can be any device capable of emitting light for display or illumination purposes. The antenna device can be, for example, a liquid crystal antenna or other types of antennas. The sensing device can be a sensing device that senses capacitance, light, heat, or ultrasound. The medical device can be a medical testing device. The tiling device can be a display tiling device or an antenna tiling device, but is not limited thereto. The electronic device can include electronic components, which can include passive components and active components, such as capacitors, resistors, inductors, diodes, electrowetting elements, transistors, bare dies, or chips. The diode can be a bare die or a chip, and can include a light-emitting diode (LED), a photodiode, or a varactor, but is not limited thereto. The transistor can include, for example, a top-gate thin-film transistor, a bottom-gate thin-film transistor, or a dual-gate thin-film transistor, but is not limited thereto.

In the present disclosure, the display device can be any device that adopts the driving circuit of the present disclosure.

It should be noted that the reference numerals used throughout this specification are for referring to circuit components with specific functions, and not to limit them to be a specific type of transistor. In different embodiments, the same reference numeral may represent an NMOS transistor or a PMOS transistor. The specific transistor type should be based on the standard circuit symbol shown in the drawing corresponding to each embodiment. A person skilled in the art can, based on the transistor type shown in the drawings and in conjunction with the corresponding high and low potential logic signals, achieve the technical effects intended by the present disclosure.

Furthermore, in the description and claims of the present disclosure, to cover different implementations, some terms may be presented in a general manner. For example, the term "switch" in the claims may correspond to any component in the specific embodiments of this specification that can be used to turn on or off a signal/current path. Its specific implementation may include, but is not limited to, a single transistor (e.g., an NMOS or PMOS transistor), a transmission gate, or other electronic components with switching functions. When a transistor is used as a switch, its on or off state can be determined by the voltage applied to its control terminal (e.g., gate).

Similarly, terms such as "first voltage level" or "second voltage level" in the claims are used to generally refer to any specific voltage level that can be used to achieve the technical purposes of the present disclosure. These general voltage level terms can correspond to various high voltage levels or low voltage levels disclosed in the specific embodiments of this specification. Their specific voltage levels can be determined according to the design requirements of the circuit, the process type, and the characteristics of the associated transistors, and are not intended to be limited to a specific voltage value. A person skilled in the art should understand the correspondence between these terms.

It should be noted that the technical features in the different embodiments described below can be replaced, reorganized, or mixed with each other to form another embodiment without departing from the spirit of the present disclosure.

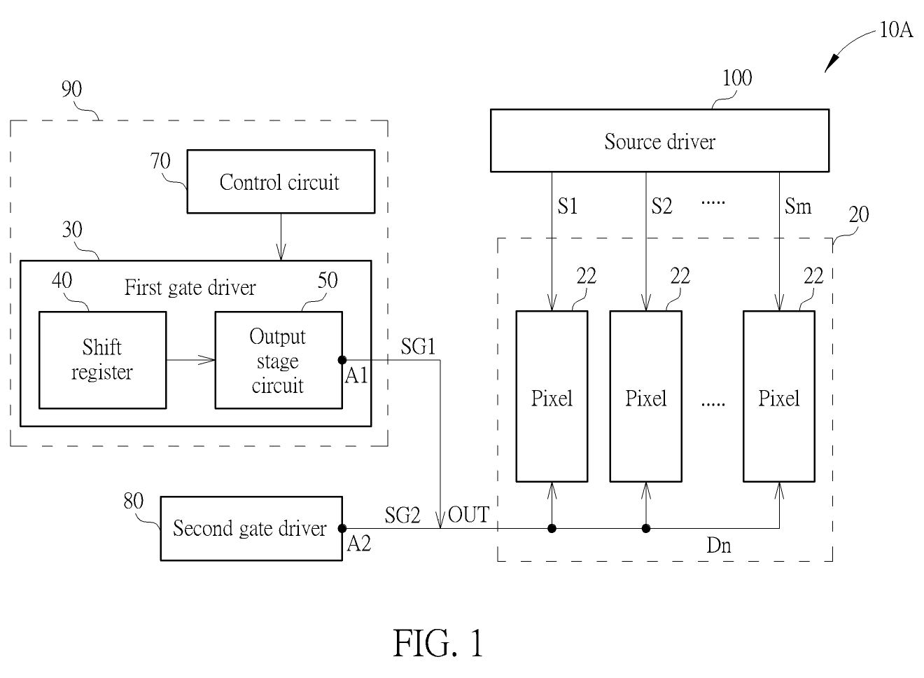

Please refer to FIG. 1, which is a schematic block diagram of a display device 10A according to some embodiments of the present disclosure. The display device 10A adopts a dual gate driver architecture, including a substrate 20, a first gate driver 30, a second gate driver 80, and a control circuit 70. A plurality of pixels 22 are disposed on the substrate 20 in a matrix form or other suitable forms, and are coupled to a plurality of data lines S1 to Sm and a plurality of gate lines (e.g., a gate line Dn). Here, the figure only illustrates one row of pixels 22 coupled to one gate line Dn for exemplary purposes. The substrate 20 may include, for example, a rigid substrate or a flexible substrate. Each pixel 22 may include multiple sub-pixels or light-emitting elements, such as red, green, and blue light-emitting diodes, to produce a full-color display. Alternatively, each pixel 22 may use blue light or ultraviolet light-emitting elements with color conversion materials (such as phosphorescent materials or quantum dot materials) to produce different colors. Each light-emitting element is typically driven by a driving circuit, which may include active components such as transistors. The display device 10A may further include a source driver 100, and the source driver 100 is coupled to the data lines S1 to Sm for providing image data signals to the pixels 22. The first gate driver 30 and the second gate driver 80 are commonly coupled to the gate line Dn for providing a gate driving signal to the pixels 22. In the dual gate driver architecture of the present disclosure, the first gate driver 30 and the second gate driver 80 can operate in different driving modes to meet the driving requirements of the display device 10A in different operating stages.

In this embodiment, the first gate driver 30 may be a Gate on Panel (GOP) circuit integrated on the substrate 20, which may include a shift register 40 and an output stage circuit 50. The shift register 40 is used to generate and shift control signals according to a timing sequence. The output stage circuit 50 is electrically coupled to the shift register 40 and is used to generate a gate signal SG1 and output it from an output terminal A1 based on the received control signals. The second gate driver 80 may be an external gate driver chip (Gate IC), which can be bonded to the substrate 20 through technologies such as Chip on Glass (COG) or Chip on Film (COF), and outputs a gate signal SG2 from an output terminal A2. The output terminal A1 of the first gate driver 30 and the output terminal A2 of the second gate driver 80 are electrically coupled to a common output node, such that the gate signal SG1 and the gate signal SG2 jointly provide a gate driving signal OUT to the gate line Dn. The control circuit 70 is electrically coupled to the first gate driver 30 for enabling or disabling the first gate driver 30 according to the current driving mode. In the present disclosure, the first gate driver 30 and the control circuit 70 can jointly form a circuit 90, and the detailed circuit structure of the circuit 90 will be described in subsequent embodiments.

The operation of the display device 10A can be divided into two driving modes: a first driving mode (i.e., test mode) and a second driving mode (i.e., display mode). In the first driving mode, for example, during the functional test stage before the display panel leaves the factory, the second gate driver 80 has not yet been bonded to the substrate 20. At this time, the control circuit 70 enables the first gate driver 30 to operate normally to drive the gate line Dn. Since the first gate driver 30 is directly integrated on the display panel, it can provide a stronger driving capability than external test equipment to effectively overcome the heavy gate line resistance-capacitance (RC) load caused by large size, high resolution, or narrow bezel designs, thereby ensuring the accuracy of the test results. In the second driving mode, for example, when the finished product of the display device 10A is assembled for normal viewing by a user, the driving of the gate line Dn is mainly handled by the bonded second gate driver 80. To prevent the gate signal SG1 output from the first gate driver 30 and the gate signal SG2 output from the second gate driver 80 from causing a signal conflict on the gate line Dn and interfering with normal display, the control circuit 70 disables the first gate driver 30. Specifically, the control circuit 70 controls the output stage circuit 50 to cause its output terminal A1 to enter a high-impedance floating state. In this way, the first gate driver 30 can be effectively electrically isolated from the driving path, and the driving authority of the gate line Dn is handed over to the second gate driver 80, thereby improving the overall quality and reliability of the product.

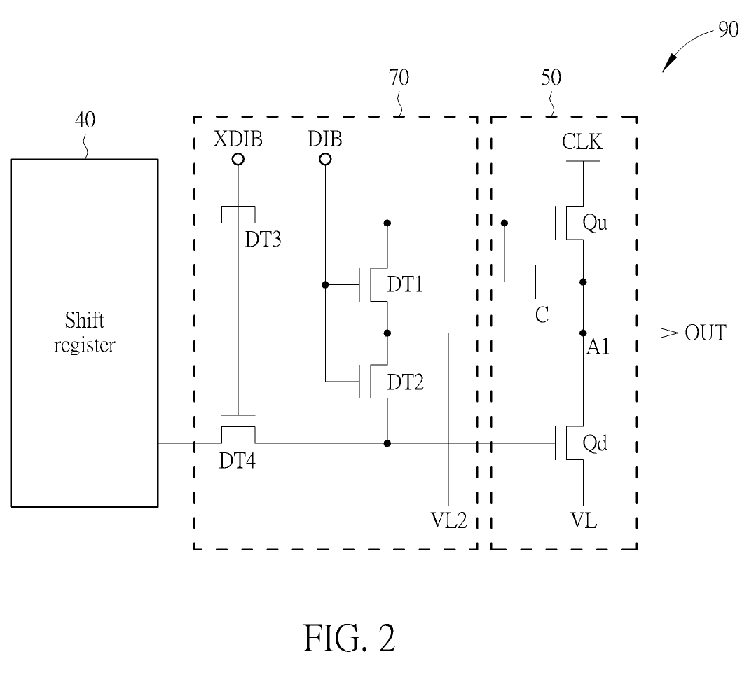

Please refer to FIG. 2, which is a circuit diagram of a first implementation of the circuit 90 shown in FIG. 1. In this embodiment, all transistors in the circuit 90 can be NMOS (N-type Metal-Oxide-Semiconductor) transistors to simplify the manufacturing process. The circuit 90 includes a shift register 40, an output stage circuit 50, and a control circuit 70 which serves as a disabling circuit. The output stage circuit 50 includes a transistor Qu, a transistor Qd, and a capacitor C. The transistor Qu acts as a pull-up transistor, with its drain coupled to a clock signal CLK and its source coupled to the output terminal A1, for pulling up the gate driving signal OUT to the potential of the clock signal CLK in the first driving mode. The transistor Qd acts as a pull-down transistor, with its drain coupled to the output terminal A1 and its source coupled to a low voltage level VL, for pulling down the gate driving signal OUT to the low voltage level VL in the first driving mode. The capacitor C is coupled between the gate of the transistor Qu and the output terminal A1 to implement a bootstrapping effect in the first driving mode, ensuring that the transistor Qu can be turned on. The control circuit 70 includes a transistor DT1, a transistor DT2, a transistor DT3, and a transistor DT4, and receives a first signal DIB and a second signal XDIB, wherein the second signal XDIB has a potential complementary to that of the first signal DIB. The transistor DT3 and the transistor DT4 act as signal path switches. The transistor DT3 is coupled between an output terminal of the shift register 40 and the gate of the transistor Qu. The transistor DT4 is coupled between another output terminal of the shift register 40 and the gate of the transistor Qd. The gates of the transistor DT3 and the transistor DT4 are commonly coupled to the second signal XDIB. The transistor DT1 and the transistor DT2 act as pull-down switches for forcibly pulling the gates of the transistors of the output stage circuit 50 to a low voltage level in the second driving mode. One terminal of the transistor DT1 is coupled to the gate of the transistor Qu, and the other terminal is coupled to a low voltage level VL2. One terminal of the transistor DT2 is coupled to the gate of the transistor Qd, and the other terminal is coupled to the low voltage level VL2. The gates of the transistor DT1 and the transistor DT2 are commonly coupled to the first signal DIB. To ensure that the transistor Qu and the transistor Qd can be effectively turned off in the second driving mode, the low voltage level VL2 can be designed to be less than or equal to a sum of the low voltage level VL and the threshold voltage of the transistor Qd (i.e., VL+Vth), where Vth is the threshold voltage of the transistor Qd.

Next, the operation of the circuit 90 in FIG. 2 in different driving modes is explained. During the first driving mode (i.e., the test mode), the control circuit 70 provides a first signal DIB at a low voltage level and a second signal XDIB at a high voltage level. At this time, the transistors DT1 and DT2 remain in a cut-off state because their gates receive the first signal DIB at the low voltage level. Meanwhile, the transistors DT3 and DT4 are turned on because their gates receive the second signal XDIB at the high voltage level. As a result, the control signals output from the shift register 40 can be transmitted to the gates of the transistor Qu and the transistor Qd through the turned-on transistors DT3 and DT4, respectively, thereby controlling the normal operation of the output stage circuit 50. In this way, the output stage circuit 50 can normally generate the gate driving signal OUT based on the control signals from the shift register 40. During the second driving mode (i.e., the display mode), the first signal DIB at a high voltage level and the second signal XDIB at a low voltage level cause the transistors DT3 and DT4 to be turned off, thereby cutting off the signal path between the shift register 40 and the output stage circuit 50. At the same time, the transistors DT1 and DT2 are turned on, pulling down the gates of the transistor Qu and the transistor Qd to the low voltage level VL2. When the gates of both the transistor Qu and the transistor Qd are pulled to the low voltage level VL2, both the transistor Qu and the transistor Qd are in a cut-off state, causing the output terminal A1 of the output stage circuit 50 to be in a high-impedance floating state, thus effectively disabling the first gate driver 30.

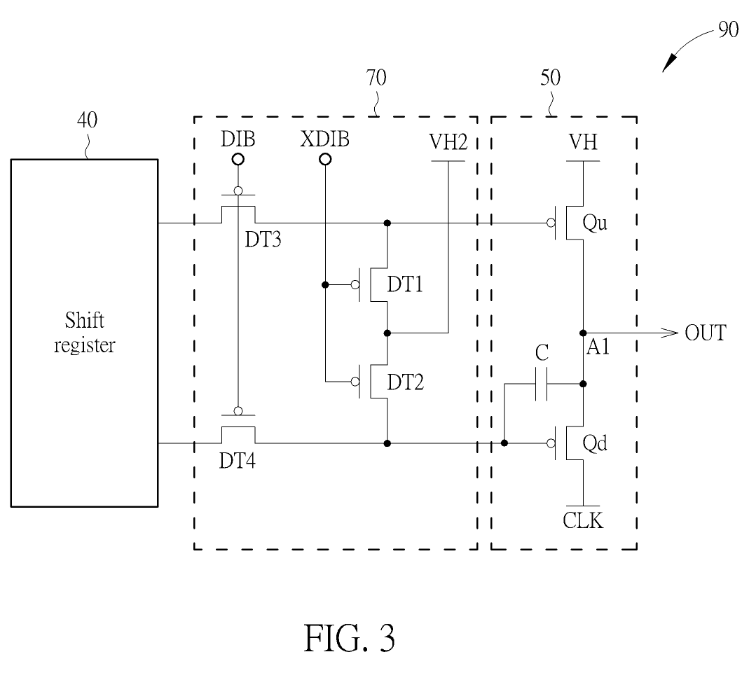

Please refer to FIG. 3, which is a circuit diagram of a second implementation of the circuit 90 shown in FIG. 1. The circuit of FIG. 3 is similar to the embodiment of FIG. 2, with the main difference being that the transistors in FIG. 3 can all be PMOS (P-type Metal-Oxide-Semiconductor) transistors. To accommodate the configuration of these PMOS transistors, the coupling position of the capacitor C, the application points of the first signal DIB and the second signal XDIB, and the configuration of the clock signal CLK and the high voltage level VH in this embodiment have all been adjusted accordingly to match the characteristics of PMOS transistors. For example, the transistors DT1 and DT2 act as pull-up switches, with their gates controlled by the second signal XDIB, to pull up the gates of the transistors Qu and Qd to a high voltage level VH2 when the first gate driver 30 is disabled.

To ensure that the output stage circuit 50 of the first gate driver 30 can be effectively disabled in the second driving mode (i.e., transistors Qu and Qd can be correctly turned off), the high voltage level VH2 can be designed to be greater than or equal to the high voltage level VH plus the threshold voltage of the transistor Qu (i.e., VH+Vth), to ensure that the transistor Qu can be turned off, where Vth is the threshold voltage of the transistor Qu, and the high voltage level VH can be higher than the ground potential.

The operation of the circuit 90 in FIG. 3 in different driving modes is described below. During the first driving mode (i.e., the test mode), the low-potential first signal DIB and the high-potential second signal XDIB cause the transistors DT3 and DT4 to turn on, and turn off the transistors DT1 and DT2. Therefore, the control signals from the shift register 40 can smoothly pass through the turned-on transistors DT3 and DT4 to control the output stage circuit 50 to normally output the gate driving signal OUT. During the second driving mode (i.e., the display mode), the high-potential first signal DIB and the low-potential second signal XDIB cause the transistors DT3 and DT4 to turn off, and turn on the transistors DT1 and DT2. In this way, the gates of the transistor Qu and the transistor Qd are pulled up to the high voltage level VH2 through the turned-on transistors DT1 and DT2. When the gates of both are at a high voltage level, both the transistor Qu and the transistor Qd will be turned off, causing the output terminal A1 of the output stage circuit 50 to be in a high-impedance floating state.

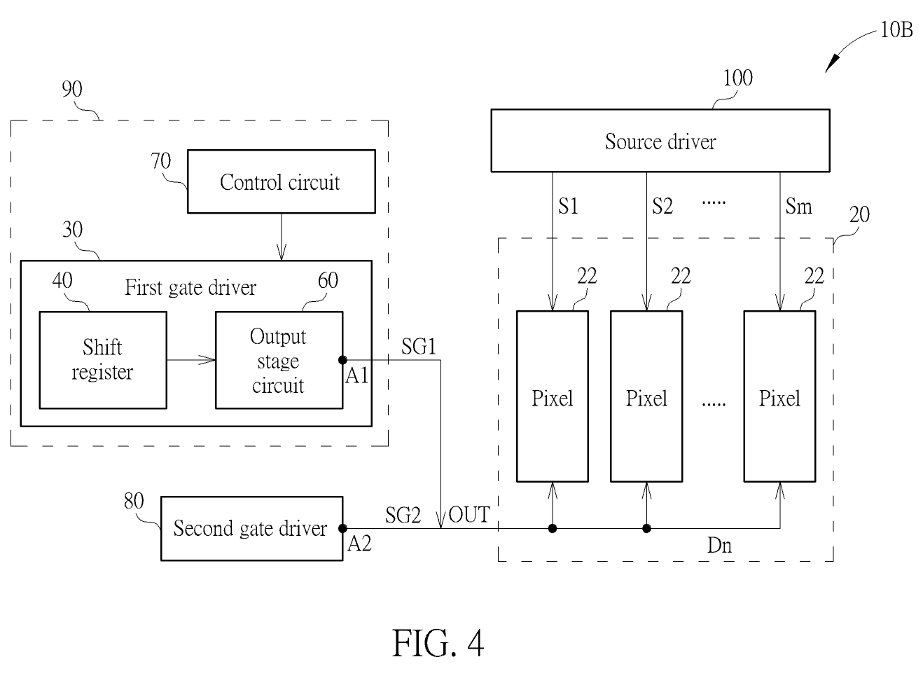

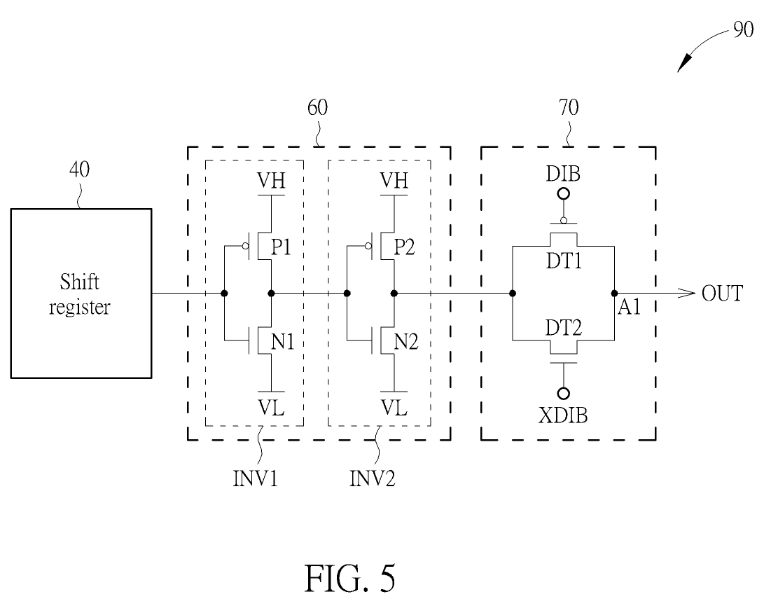

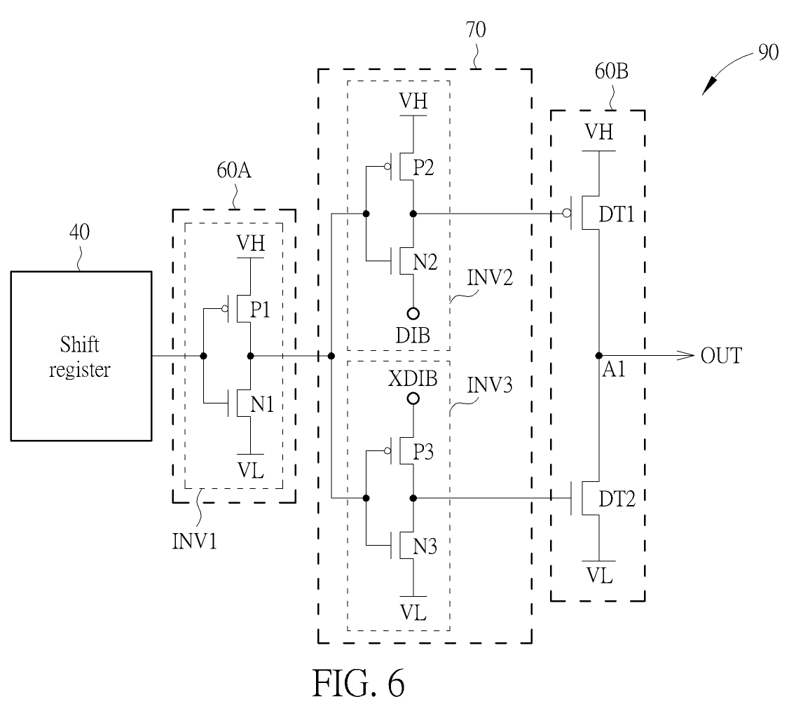

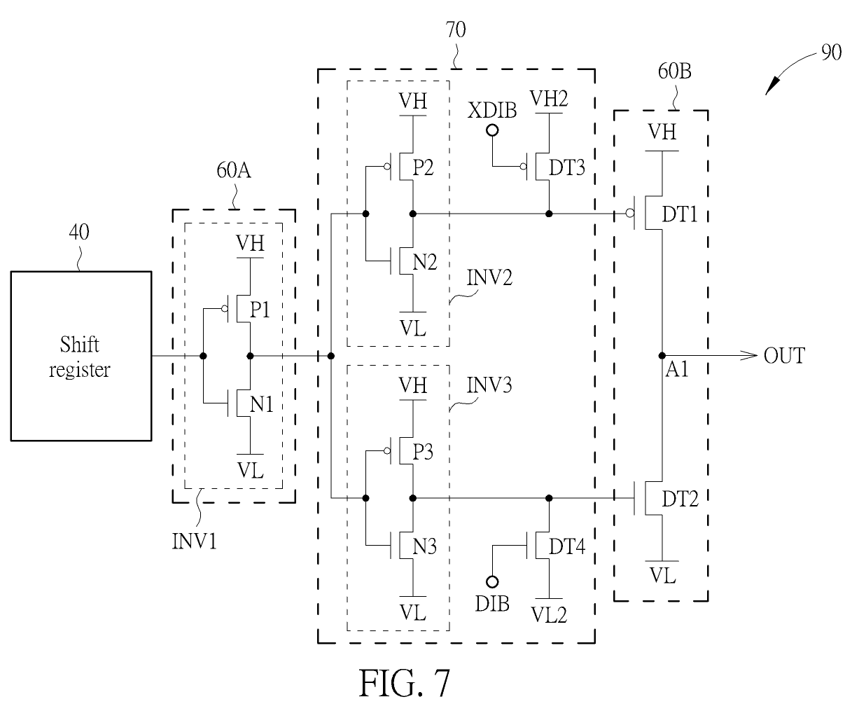

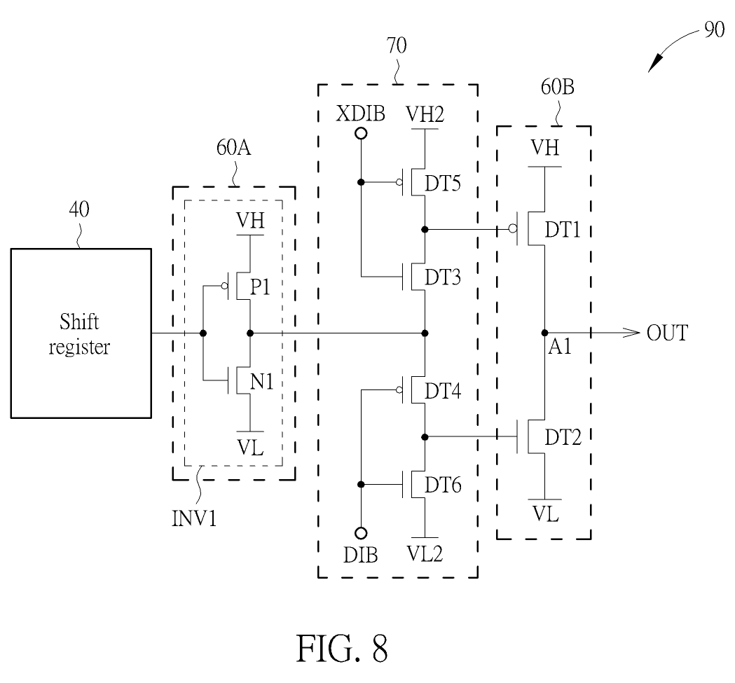

Please refer to FIG. 4, which is a schematic block diagram of a display device 10B according to another embodiment of the present disclosure. The overall architecture of the display device 10B is similar to that of the display device 10A in FIG. 1; both have a dual gate driver architecture, and the relationship between the relevant components can be referred to the description of FIG. 1, which will not be repeated here. The main difference between this embodiment and the embodiment of FIG. 1 is that the first gate driver 30 replaces the output stage circuit 50 of FIG. 1 with a gate buffer 60. The operating mode of this embodiment is similar to the aforementioned embodiments; the control circuit 70 is also used to enable the first gate driver 30 in the first driving mode and disable the first gate driver 30 in the second driving mode, causing its output terminal A1 to be in a high-impedance floating state. In this embodiment, the circuit 90, including the gate buffer 60 and the control circuit 70, can be implemented using the circuit structures shown in the subsequent FIG. 5, FIG. 6, FIG. 7, or FIG. 8.

Please refer to FIG. 5, which is a circuit diagram of an implementation of the circuit 90 shown in FIG. 4. The circuit 90 of this embodiment adopts a complementary metal-oxide-semiconductor (CMOS) architecture. The circuit 90 includes a shift register 40, a gate buffer 60, and a control circuit 70. The gate buffer 60 includes an inverter INV1 and an inverter INV2 coupled in series, where the inverter INV1 and the inverter INV2 connected in series form a non-inverting buffer, used to provide a buffered signal that is in phase with the original input. The inverter INV1 includes a transistor P1 and a transistor N1 connected in series. In this embodiment, the transistor P1 can be a PMOS transistor, and the transistor N1 can be an NMOS transistor. The gates of the transistor P1 and the transistor N1 are commonly coupled to the output terminal of the shift register 40. The source of the transistor P1 is coupled to a high voltage level VH, and the source of the transistor N1 is coupled to a low voltage level VL. The drains of the transistor P1 and the transistor N1 are coupled to each other to serve as the output terminal of the inverter INV1. The inverter INV2 includes a transistor P2 and a transistor N2, and its circuit structure is similar to that of the inverter INV1. The input terminal of the inverter INV2 is coupled to the output terminal of the inverter INV1, and its output terminal is coupled to the control circuit 70. The control circuit 70 can include a transmission gate, which is composed of a transistor DT1 and a transistor DT2. This transmission gate is electrically coupled between the output terminal of the gate buffer 60 and the output terminal A1, and is used to selectively conduct or cut off the signal path. In this embodiment, the transistor DT1 can be a PMOS transistor, and the transistor DT2 can be an NMOS transistor. The gate of the transistor DT1 is controlled by a first signal DIB, and the gate of the transistor DT2 is controlled by a second signal XDIB, which is complementary in potential to the first signal DIB. The operation of the circuit 90 in FIG. 5 in different driving modes is described below. During the first driving mode (i.e., the test mode), the low-potential first signal DIB and the high-potential second signal XDIB cause both the transistor DT1 and the transistor DT2 to turn on, thereby opening the transmission gate. Therefore, the signal output from the gate buffer 60 can smoothly pass through the turned-on control circuit 70 to normally output the gate driving signal OUT. During the second driving mode (i.e., the display mode), the high-potential first signal DIB and the low-potential second signal XDIB cause both the transistor DT1 and the transistor DT2 to turn off, thereby closing the transmission gate and cutting off the signal path between the gate buffer 60 and the output terminal A1. At this time, the output terminal A1 is in a high-impedance floating state, thereby effectively disabling the first gate driver 30.

Please refer to FIG. 6, which is a circuit diagram of another implementation of the circuit 90 of FIG. 4. The circuit 90 of this embodiment includes a shift register 40, a first gate buffer 60A, a control circuit 70, and a second gate buffer 60B. In this design, the control circuit 70 is placed between two buffer stages. The first gate buffer 60A includes an inverter INV1, and the control circuit 70 includes an inverter INV2 and an inverter INV3, where the inverter INV3 includes a transistor P3 and a transistor N3 connected in series. Different from FIG. 5 where the control circuit is placed at the output terminal, this embodiment controls the state of the final output stage (i.e., the second gate buffer 60B) by changing the power reference points of the inverter INV2 and the inverter INV3.

The operation of the circuit 90 in FIG. 6 in different driving modes is described below. During the first driving mode (i.e., the test mode), the low-potential first signal DIB and the high-potential second signal XDIB cause both the inverter INV2 and the inverter INV3 to operate as standard inverters, thereby enabling the entire circuit 90 to normally output signals. During the second driving mode (i.e., the display mode), a high-potential first signal DIB and a low-potential second signal XDIB are applied to the control circuit 70. At this time, regardless of the output of the inverter INV1, the inverter INV2 will drive the gate of the transistor DT1 to a high voltage level, thus turning off the transistor DT1. At the same time, the output of the inverter INV3 is pulled down to a low voltage level, thus turning off the transistor DT2. When both the transistor DT1 and the transistor DT2 in the second gate buffer 60B are forcibly turned off, the output terminal A1 is in a high-impedance floating state, thereby effectively disabling the first gate driver 30.

Please refer to FIG. 7, which is a circuit diagram of another implementation of the circuit 90 of FIG. 4. The main difference between FIG. 7 and FIG. 6 is that the control circuit 70 of this embodiment also includes a transistor DT3 and a transistor DT4, and all inverters and buffers in the circuit 90 are coupled between a high voltage level VH and a low voltage level VL. Specifically, the transistor DT3 is coupled between the output terminal of the inverter INV2 and a high voltage level VH2, and is controlled by a second signal XDIB. The transistor DT4 is coupled between the output terminal of the inverter INV3 and a low voltage level VL2, and is controlled by a first signal DIB. The gate of the transistor DT1 is coupled to the output terminal of the inverter INV2 and the transistor DT3, and the gate of the transistor DT2 is coupled to the output terminal of the inverter INV3 and the transistor DT4.

Next, the operation of the circuit 90 in FIG. 7 in different driving modes is described. During the first driving mode (i.e., the test mode), the low-potential first signal DIB and the high-potential second signal XDIB cause both the transistor DT3 and the transistor DT4 to remain in a cut-off state. In this state, the second gate buffer 60B normally outputs the gate driving signal OUT. During the second driving mode (i.e., the display mode), the high-potential first signal DIB and the low-potential second signal XDIB cause both the transistor DT3 and the transistor DT4 to turn on. The turned-on transistor DT3 will pull up the gate of the transistor DT1 to the high voltage level VH2, causing the transistor DT1 to turn off. At the same time, the turned-on transistor DT4 will pull down the gate of the transistor DT2 to the low voltage level VL2, causing the transistor DT2 to turn off. When both the transistor DT1 and the transistor DT2 in the second gate buffer 60B are turned off, the output terminal A1 is in a high-impedance floating state, thereby effectively disabling the first gate driver 30. To ensure that the transistor DT1 and the transistor DT2 can be effectively turned off, the high voltage level VH2 can be designed to be greater than or equal to the high voltage level VH plus the threshold voltage of the transistor DT1 (i.e., VH+Vth1), and the low voltage level VL2 can be designed to be less than or equal to the low voltage level VL plus the threshold voltage of the transistor DT2 (i.e., VL+Vth2), where Vth1 is the threshold voltage of the transistor DT1, and Vth2 is the threshold voltage of the transistor DT2.

Please refer to FIG. 8, which is a circuit diagram of another implementation of the circuit 90 of FIG. 4. The circuit 90 of this embodiment is similar to that of FIG. 7. The control circuit 70 of this embodiment includes a shift register 40, a first gate buffer 60A, a control circuit 70, and a second gate buffer 60B. The main difference is that the control circuit 70 of this embodiment does not include the inverter INV2 and the inverter INV3, and the control circuit 70 of this embodiment includes two sets of switches: one set is transistors DT3 and DT4 acting as signal path switches, and the other set is transistors DT5 and DT6 acting as forcing switches. The transistors DT3 and DT4 are used to selectively transmit or block the signal from the first gate buffer 60A. The transistors DT5 and DT6 are used to forcibly drive the input of the second gate buffer 60B to a specific potential when the signal is blocked.

The operation of the circuit 90 in FIG. 8 in different driving modes is described below. During the first driving mode (i.e., the test mode), the low-potential first signal DIB and the high-potential second signal XDIB cause the transistors DT3 and DT4 to turn on, while simultaneously turning off the transistors DT5 and DT6. The signal path from the first gate buffer 60A is opened, and the signal output from the shift register 40 can be smoothly transmitted to the input terminal of the second gate buffer 60B, thereby normally controlling the transistors DT1 and DT2 to output the gate driving signal OUT. During the second driving mode (i.e., the display mode), the high-potential first signal DIB and the low-potential second signal XDIB cause the transistors DT3 and DT4 to turn off, and turn on the transistors DT5 and DT6, thereby blocking the signal path from the first gate buffer 60A. At the same time, the turned-on transistor DT5 will pull up the gate of the transistor DT1 to the high voltage level VH2, and the turned-on transistor DT6 will pull down the gate of the transistor DT2 to the low voltage level VL2, which can ensure that both the transistor DT1 and the transistor DT2 in the second gate buffer 60B are reliably turned off, causing the output terminal A1 to be in a high-impedance floating state. To ensure that the transistor DT1 and the transistor DT2 can be effectively turned off, the high voltage level VH2 can be designed to be greater than or equal to the high voltage level VH plus the threshold voltage of the transistor DT1 (i.e., VH+Vth1), and the low voltage level VL2 can be designed to be less than or equal to the low voltage level VL plus the threshold voltage of the transistor DT2 (i.e., VL+Vth2).

In summary, the present disclosure provides a display device and a driving method thereof that can selectively disable a Gate on Panel circuit. By providing a control circuit, the display device of the present disclosure can flexibly switch between two driving modes. In the first driving mode (e.g., test mode), the first gate driver (e.g., GOP circuit) is enabled and operates normally to provide sufficient driving capability to complete panel testing. In the second driving mode (e.g., display mode), the control circuit disables the first gate driver, causing its output terminal to enter a high-impedance floating state. This electrical isolation design can effectively prevent signal conflicts between the Gate on Panel circuit and an external gate driver chip. This not only simplifies the manufacturing process and reduces production costs, but also eliminates the risk of electrostatic discharge or long-term reliability issues that may arise from residual metal traces caused by physical cutting, thereby improving the overall quality and reliability of the product.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A display device, comprising:
a substrate;
a plurality of pixels, disposed on the substrate;
a first gate driver, having a first output terminal coupled to the plurality of pixels;
a second gate driver, having a second output terminal commonly coupled to the plurality of pixels; and
a control circuit, electrically coupled to the first gate driver for selectively disabling the first gate driver, wherein when the first gate driver is disabled, the first output terminal is in a floating state.

2. The display device of claim 1, wherein the first gate driver is a Gate on Panel (GOP) circuit, and the second gate driver is a gate driver chip.

3. The display device of claim 1, wherein the first gate driver further comprises:
an output stage circuit, coupled to the first output terminal, the output stage circuit comprising a pull-up transistor and a pull-down transistor; and
a shift register, coupled to the output stage circuit;
wherein when the first gate driver is disabled, the control circuit is configured to turn off the pull-up transistor and the pull-down transistor.

4. The display device of claim 3, wherein when the first gate driver is disabled, the control circuit is configured to couple the gates of the pull-up transistor and the pull-down transistor to a first voltage level.

5. The display device of claim 3, wherein the control circuit comprises:
a first switch, coupled to a gate of the pull-up transistor, and controlled by a first voltage level; and
a second switch, coupled to a gate of the pull-down transistor, and controlled by the first voltage level;
wherein when the first gate driver is disabled, the first switch and the second switch are turned on.

6. The display device of claim 1, wherein the first gate driver further comprises a gate buffer, and the control circuit is a transmission gate coupled between the gate buffer and the first output terminal.

7. The display device of claim 1, wherein the first gate driver further comprises:
a shift register;
a first gate buffer, coupled to the shift register and the control circuit; and
a second gate buffer, coupled to the control circuit and the first output terminal.

8. The display device of claim 7, wherein the second gate buffer comprises a first transistor and a second transistor, and the control circuit is coupled to a gate of the first transistor and a gate of the second transistor, and is configured to, when the first gate driver is disabled, drive the gate of the first transistor to a first voltage level and drive the gate of the second transistor to a second voltage level, wherein the first transistor is coupled between the first voltage level and the second transistor, the second transistor is coupled between the first transistor and the second voltage level, and the first voltage level is different from the second voltage level.

9. The display device of claim 1, wherein the control circuit receives a first signal and a second signal with a potential complementary to the first signal to selectively disable the first gate driver.

10. The display device of claim 1, wherein the first gate driver is enabled in a first driving mode to perform a functional test of the display device, and the first gate driver is disabled in a second driving mode for the second gate driver to drive the pixels for normal display.

11. A driving method for a display device, the display device comprising a substrate, a plurality of pixels disposed on the substrate, a first gate driver, a second gate driver, and a control circuit, wherein the first gate driver and the second gate driver are commonly coupled to the plurality of pixels, wherein the driving method comprises:
in a first driving mode, enabling the first gate driver to provide a first gate driving signal to the plurality of pixels; and
in a second driving mode, disabling the first gate driver, causing an output terminal of the first gate driver to be in a floating state, and enabling the second gate driver to provide a second gate driving signal to the plurality of pixels.

12. The driving method of claim 11, wherein the first driving mode is a test mode, and the second driving mode is a display mode.

13. The driving method of claim 11, wherein the first gate driver is a Gate on Panel (GOP) circuit, the second gate driver is a gate driver chip, and the first driving mode is executed before the gate driver chip is bonded to the substrate.

14. The driving method of claim 11, wherein the first gate driver comprises an output stage circuit, the output stage circuit comprising a pull-up transistor and a pull-down transistor, wherein disabling the first gate driver comprises turning off the pull-up transistor and the pull-down transistor.

15. The driving method of claim 14, wherein turning off the pull-up transistor and the pull-down transistor comprises coupling a gate of the pull-up transistor and a gate of the pull-down transistor to a low voltage level.

16. The driving method of claim 14, wherein turning off the pull-up transistor and the pull-down transistor comprises coupling a gate of the pull-up transistor and a gate of the pull-down transistor to a high voltage level.

17. The driving method of claim 11, wherein disabling the first gate driver comprises:
cutting off a signal path from a gate buffer within the first gate driver to the output terminal of the first gate driver by turning off a transmission gate.

18. The driving method of claim 11, wherein the first gate driver comprises a second gate buffer, the second gate buffer comprising a first transistor and a second transistor, wherein the first transistor is coupled between a first voltage level and the second transistor, the second transistor is coupled between the first transistor and a second voltage level, and the first voltage level is different from the second voltage level, and disabling the first gate driver comprises:
driving a gate of the first transistor to the first voltage level; and
driving a gate of the second transistor to the second voltage level.

19. The driving method of claim 11, wherein the driving method further comprises providing a first signal and a second signal with a potential complementary to the first signal to the control circuit to switch between the first driving mode and the second driving mode.

20. The driving method of claim 11, wherein the first gate driver comprises a shift register and an output stage circuit, and enabling the first gate driver comprises turning on a signal path between the shift register and the output stage circuit.
